(19) United States
(12) Patent Application Publication
(10) Pub. No.: US 2017/0307237 A1
(43) Pub. Date: Oct. 26, 2017

(54) AIR CONDITIONING DEVICE HAVING WATERPROOF FUNCTION

(71) Applicants: Eun-jin KANG, Seoul (KR); Gwang-seok LEE, Gyeonggi-do (KR); Jang-hyuk LEE, Gyeonggi-do (KR)

(72) Inventors: Eun-jin KANG, Seoul (KR); Gwang-seok LEE, Gyeonggi-do (KR); Jang-hyuk LEE, Gyeonggi-do (KR)

(21) Appl. No.: 15/517,163

(22) PCT Filed: Oct. 2, 2015
(86) PCT No.: PCT/KR2015/010431

§ 371 Date: Apr. 5, 2017

(30) Foreign Application Priority Data
Oct. 7, 2014 (KR) 10-2014-0135333

(51) Int. Cl. F24F 7/08; F24F 13/02; F24F 7/02; F16L 55/09; F24F 7/00; B60H 1/00

(52) U.S. Cl. CPC F24F 7/08; F24F 7/02; F16L 55/09; F24F 13/02; B60H 1/00; F24F 2007/001

(57) ABSTRACT

The present invention relates to an air conditioning device having a waterproof function, and includes a ventilation pipe whose lower end is coupled to a peripheral surface of a vent of an object at the outside of the object so as to communicate with an inner space of the object, a perforated pipe which is installed to be erected on a flat outer surface of the object in parallel with the ventilation pipe, a duct which is connected between an upper end of the ventilation pipe and an upper end of the perforated pipe such that the ventilation pipe and the perforated pipe communicate with each other, and a floating body which is positioned in the inner space of the perforated pipe and vertically moves in the inner space of the perforated pipe according to the amount of water flowing in through holes of the perforated pipe. A connection part between the perforated pipe and the duct is opened or sealed by means of vertical movement of the floating body such that the inner space of the object is ventilated with outside air through the ventilation pipe or the inner space of the object is closed.

### TECHNICAL FIELD

The present invention relates to an air conditioning device which can simultaneously perform air conditioning and waterproofing of an inner space of an object.

### BACKGROUND ART

Conventionally, since electrical equipment such as a transformer, a switch, and a communication device is installed in an upper end of a large ground facility such as an electric pole, it was difficult and dangerous to maintain the electric equipment because an electric equipment manager had to climb the electric pole to maintain and repair the electric equipment. In addition, demand for the electrical equipment explosively increases according to the rapid industrialization of modern society, and thereby, lots of electrical equipment related facilities such as the electric poles were installed all over the city. As a result, the electrical equipment related facilities hurt beauty of the city, hindered an efficient use of urban space, and caused a threat to safety of citizens of the city.

Recently, a cable undergrounding project has been progressing in which a cable connected between the electrical equipment is buried underground and the electrical equipment is installed on the road surface such as a sidewalk. However, since the electrical equipment is installed on the ground surface, the electrical equipment causes inconvenience of pedestrians and it is frequently reported that electrical equipment is flooded or damaged due to repeated rainy season and typhoon every year. In addition, it is also frequently reported that a vehicle collides with the electrical equipment due to driver's carelessness. Flooding or destruction of the electrical equipment causes fire, electric shock, explosion, or the like, thereby, leading to massive property loss and personal injury.

Accordingly, various attempts to bury the electrical equipment underground have been made. Since flooding of the electrical equipment leads directly to failure of the electrical equipment and accidents, waterproofing of the electrical equipment should be solved first when the electrical equipment is buried underground. If the electrical equipment is installed in a sealed underground space for waterproofing the electrical equipment, the underground space where the electrical equipment is installed cannot be ventilated with outside air, and thus, not only it is not easy to release the heat generated from the electrical equipment, and but also it is difficult to maintain the same humidity as on the ground. The facility can be installed on the ground such that the underground space where the electrical equipment is installed can be ventilated with outside air so as to maintain the heat and humidity of the electrical equipment, but there is a problem in which that the effect of the underground burial of the electrical equipment is not great because the ground facility also has the same problems as the electrical equipment.

### DETAILED DESCRIPTION OF THE INVENTION

### Technical Problem

There is provided an air conditioning device which can simultaneously perform air conditioning and waterproofing of an inner space of an object at a low cost without installing a separate ground facility for waterproofing the inner space of the object and can be installed at the same height as a ground surface. The present invention is not limited to the aforementioned technical solutions, and another technical solution can also be derived from the following description.

### Technical Solution

An air conditioning device according to an aspect of the present invention includes at least one ventilation pipe whose lower end is coupled to a peripheral surface of at least one vent of an object at the outside of the object so as to communicate with an inner space of the object, at least one perforated pipe which is installed to be erected on a flat outer surface of the object in parallel with the each ventilation pipe, a duct which is connected between upper ends of the each ventilation pipe and an upper end of the at least one perforated pipe such that the each ventilation pipe and the at least one perforated pipe communicate with each other, and at least one floating body which is positioned in each inner space of the at least one perforated pipe, and vertically moves in the inner spaces of the each perforated pipe according to the amount of water flowing in through holes of the each perforated pipe. Connection parts between the each perforated pipe and the duct are opened or sealed by means of vertical movements of the each floating body such that the inner space of the object is ventilated with outside air through the ventilation pipe or the inner space of the object is closed.

The each floating body may be lighter than buoyance of water and may be a circular ball at one side of which a protruding rod is formed, and the air conditioning device may further include a guide member which is installed on the upper end sides of the each perforated pipe and guides vertical movements of the each floating body by including paths in which the protruding rods of the each floating body are inserted to slidably move while air passes through the paths. The air conditioning device may further include a sealing packing of a circular shape whose upper surface is coupled to a lower surface of the guide member in a sealed state and in which a circular opening is formed in a center thereof, and if water flows into holes of the each perforated pipe and the each perforated pipe is immersed in water at a height above a critical water level, circular outer surfaces of the each floating body may press peripheries of holes of the each sealing packing and thereby connection parts between the each perforated pipe and the duct may be sealed. The each perforated pipe may have a larger diameter than a maximum diameter which can be immersed in water flowing into the holes of the each perforated pipe at a maximum flow speed.

The at least one perforated pipe may be a plurality of perforated pipes which are installed to be erected on a flat outer surface of the object in parallel with the ventilation pipe, and the duct may be connected between upper ends of the each ventilation pipe and upper ends of the plurality of perforated pipes such that the each ventilation pipe and the plurality of perforated pipes communicate with each other.

The at least one ventilation pipe may include a supply pipe whose lower end is coupled to a periphery of a supply hole of the object in a sealed state and which communicates with an inner space of the object, and an exhaust pipe which is coupled to a periphery of an exhaust hole of the object in a sealed state and communicates with the inner space of the object. The at least one perforated pipe may include at least one supply perforated pipe which is installed to be erected on the flat outer surface of the object in parallel with the supply pipe, and at least one exhaust perforated pipe which is installed to be erected on the flat outer surface of the object in parallel with the exhaust pipe. The duct may include a supply duct which is connected between an upper end of the supply pipe and an upper end of the at least one supply perforated pipe such that the supply pipe and the at least one supply perforated pipe communicate with each other, and an exhaust duct which is connected between an upper end of the exhaust pipe and an upper end of the at least one exhaust perforated pipe such that the exhaust pipe and the at least one exhaust perforated pipe communicate with each other.

The air conditioning device may further include a fan which is coupled to a periphery surface of the supply hole of the object in an inside of the object so as to absorb air from the outside of the object, which is coupled to a periphery surface of the exhaust hole of the object in an inside of the object so as to exhaust air to the outside of the object through the exhaust pipe, and which forcibly circulates the air that is absorbed through the supply pipe in the inner space of the object to exhaust the air through the exhaust pipe.

The fan may include a supply fan which is coupled to the peripheral surface of the supply hole of the object in a sealed state or non-sealed state and absorbs air from the outside of the object through the supply pipe, and an exhaust fan which is coupled to the peripheral surface of the exhaust hole of the object in a non-sealed state and exhausts air to the outside of the object through the exhaust pipe. A gap which enables wind power smaller than buoyance of a floating body occurring due to water that is flowed in through the holes of the each exhaust perforated pipe to act on a floating body that is positioned in an inner space of the each exhaust perforated pipe may be formed between the exhaust fan and the peripheral surface of the exhaust hole of the object.

The air conditioning device may further include a control unit which measures at least one of positions of each floating body in the inner spaces of the each supply perforated pipe and positions of each floating body in the inner spaces of the each exhaust perforated pipes, and controls drive of the fan depending on whether or not the measurement result indicates at least one sealing of connection parts between the each supply perforated pipe and the supply duct and connection parts between the each exhaust perforated pipe and the exhaust duct.

The fan may include a supply fan which is coupled to the peripheral surface of the supply hole of the object and absorbs air from the outside of the object through the supply pipe, and an exhaust fan which is coupled to the peripheral surface of the exhaust hole of the object in a non-sealed state and exhausts air to the outside of the object through the exhaust pipe. A gap which enables wind power smaller than buoyance of a floating body occurring due to water that is flowed in through the holes of the each exhaust perforated pipe to act on a floating body that is positioned in an inner space of the each exhaust perforated pipe may be formed between the exhaust fan and the peripheral surface of the exhaust hole of the object.

The air conditioning device may further include a control unit which measures at least one of positions of each floating body in the inner spaces of the each supply perforated pipe and positions of each floating body in the inner spaces of the each exhaust perforated pipes, and controls drive of the fan depending on whether or not the measurement result indicates at least one sealing of connection parts between the each supply perforated pipe and the supply duct and connection parts between the each exhaust perforated pipe and the exhaust duct.

The fan may include a supply fan which is coupled to the peripheral surface of the supply hole of the object and absorbs air from the outside of the object through the supply pipe, and an exhaust fan which is coupled to the peripheral surface of the exhaust hole of the object and exhausts air to the outside of the object through the exhaust pipe. The control unit may stop drives of the supply fan and the exhaust fan if the measurement result indicates at least one sealing of the connection parts between the each supply perforated pipe and the supply duct and the connection parts between the each exhaust perforated pipe and the exhaust duct, may stop the drives of the supply fan and the exhaust fan if the measurement result indicates opening of all of the connection parts between the each supply perforated pipe and the supply duct and connection parts between the each exhaust perforated pipe and the exhaust duct and temperature of the inner space of the object is lower than or equal to a critical temperature, and may drive the supply fan and the exhaust fan if the measurement result indicates opening of all of the connection parts between the each supply perforated pipe and the supply duct and connection parts between the each exhaust perforated pipe and the exhaust duct and the temperature of the inner space of the object is higher than the critical temperature.

The air conditioning device may further include a proximity sensor which is installed on at least one of upper end sides of the each supply perforated pipe and upper end sides of the each exhaust perforated pipe, detects degrees of proximity of each floating body vertically moving in inner spaces of the each supply perforated pipe, and detects degrees of proximity of each floating body vertically moving in inner spaces of the each exhaust perforated pipe. The control unit may measure positions of each floating body in inner spaces of the each supply perforated pipe from the degrees of proximity of each floating body vertically moving in the inner spaces of the each supply perforated pipe, and may measure positions of each floating body in inner spaces of the each exhaust perforated pipe from the degrees of proximity of each floating body vertically moving in the inner spaces of the each exhaust perforated pipe.

### Advantageous Effects of the Invention

There can be provided an air conditioning device that is installed in an object having an inner space, which simultaneously requires air conditioning and waterproofing, such as electrical equipment container that is buried under ground, and that includes an air conditioning function of an apparatus installed in the inner space of the object by means of natural convection and of maintaining humidity and the like in a state similar to the outside by ventilating the inner space of the object with outside air in usual time, and a waterproof function of preventing the apparatus installed in the inner space of the object from flooding by closing the inner space of the object when water flows into the air conditioning device due to rainfall or the like. As such, as the air conditioning device includes the waterproof function in addition to the air conditioning function, air conditioning and waterproofing of the inner space of the object can be simultaneously performed at a very low cost without installing a separate ground facility for waterproofing the inner space of the object and can be installed at the same height as a ground surface, and thus, inconveniences of pedestrians due to a ground facility, vehicle accidents, and the like are eliminated.

In addition, as each floating body which opens or seals connection parts between each perforated pipe and a duct is guided by a guide member so as to be able to vertically move in proportion to the amount of water flowing into each perforated pipe without shaking in the insides of each perforated pipe, a period in which the inner space of the object is ventilated with the outside air can be secured as long as possible by preventing the connection parts between each perforated pipe and the duct from being sealed, and flow of rainwater into the inner space of the object can be certainly blocked by preventing the connection parts between each perforated pipe and the duct from being opened during rainfall.

In addition, by employing a perforated pipe which is a member for inflow and outflow of air and water and simultaneously performs a role of applying buoyance to a floating body by containing rainwater falling to the air conditioning device while guiding each floating body to vertically move without shaking, the air conditioning device has a very simple structure and can be easily separated from the object, and thus, it is very easy to replace, repair, and manage the air conditioning device. In addition, by installing a plurality of perforated pipes with respect to one ventilation pipe, one supply pipe, and one exhaust pipe, it is possible to supplement ventilation capacity which can decrease due to employment of a structure in which air can flow or cannot flow through the ventilation pipe, the supply pipe, and the exhaust pipe.

In addition, by separately configuring the supply side and the exhaust side, not only a smoother air circulation between the inner space and an outer space of the object can be performed, but also forcible air circulation between the inner space and the outer space of the object can be performed by using a fan. Accordingly, temperature and humidity of the inner space of the object can be maintained in a state similar to the outside, and thereby, overheat and excessive moisture of electrical equipment installed in the inner space of the object can be prevented. As a result, it is possible to not only greatly reduce a failure rate of the electrical equipment installed in the inner space of the object, but also extend a life span of the electrical equipment since the electrical equipment operates in an optimal state.

In addition, if at least one of connection parts between each supply perforated pipe and a supply duct and connection parts between each exhaust perforated pipe and an exhaust duct is sealed, overheat of each fan and unnecessary power consumption can be prevented by stopping a supply fan and an exhaust fan. It is possible to rapidly cool an apparatus when an apparatus in the inner space of the object overheats, by stopping the supply fan and the exhaust fan, if temperature of the inner space of the object is lower than or equal to a critical temperature in a state where the connection parts between each supply perforated pipe and the supply duct and the connection parts between each exhaust perforated pipe and the exhaust duct are all opened, and by driving the supply fan and the exhaust fan, if temperature of the inner space of the object is higher than the critical temperature in a state where the connection parts between each supply perforated pipe and the supply duct and the connection parts between each exhaust perforated pipe and the exhaust duct are all opened, and it is possible to minimize power consumption according to the drives of each fan by making the best use of cooling which is performed by the natural convection.

### DESCRIPTION OF THE DRAWINGS

FIG. 1 is an exploded view of an air conditioning device according to one embodiment of the present invention.

FIG. 2 is an internal view of the air conditioning device illustrated in FIG. 1.

FIG. 3 is a sectional view of the air conditioning device illustrated in FIG. 1.

FIG. 4 is a view illustrating an operation that the air conditioning device illustrated in FIG. 1 ventilates an inner space of an object 100.

FIG. 5 is a view illustrating an operation that the air conditioning device illustrated in FIG. 1 closes the inner space of the object 100.

FIG. 6 is an exploded view of an air conditioning device according to another embodiment of the present invention.

FIG. 7 is an exploded view of a fan 5 of an air conditioning device according to still another embodiment of the present invention.

FIG. 8 is a perspective view of the fan 5 illustrated in FIG. 7.

FIG. 9 is a plan view of the fan 5 illustrated in FIG. 7.

### MODE OF THE INVENTION

Hereinafter, embodiments of the present invention will be described in detail with reference to the drawings. Electrical equipment such as a transformer or a switch can be installed in a space, into which rainwater can flow, such as an underground space. In order to prevent the electrical equipment vulnerable to water and heat from deteriorating and or breaking down, the space where the electrical equipment is installed requires air conditioning and waterproofing. Hereinafter, in addition to the electrical equipment, fluid vulnerable to water and heat will be comprehensively referred to as an “apparatus”, and various facilities having an inner space requiring air conditioning and waterproofing for accommodating the apparatus will be comprehensively referred to as an “object”. Embodiments which will be described below relate to an air conditioning device that is installed on an outer surface of an object having an inner space in which an apparatus vulnerable to water and heat is installed and that can perform ventilation of the inner space of the object simultaneously with waterproofing of the inner space.

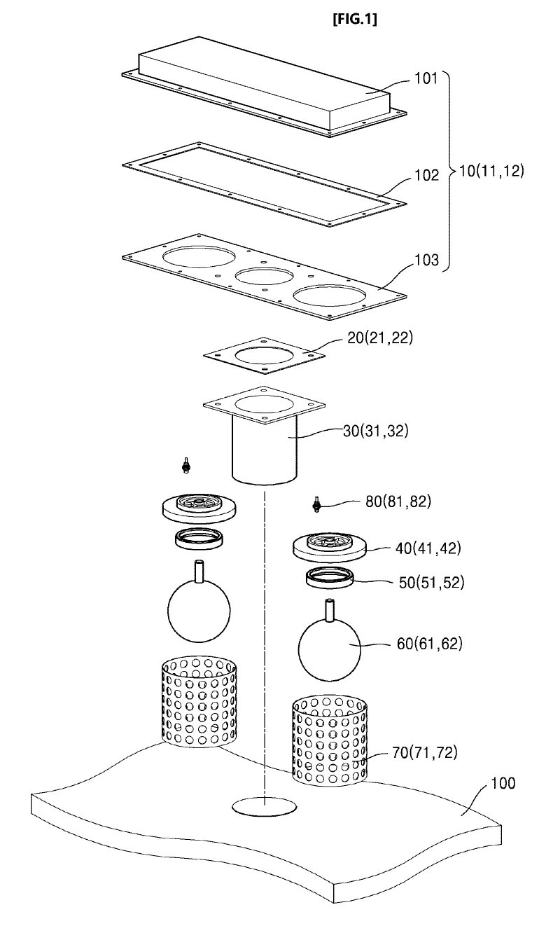

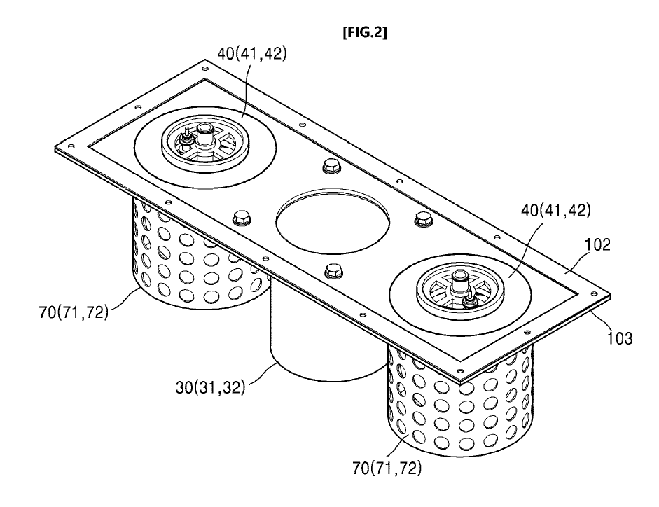

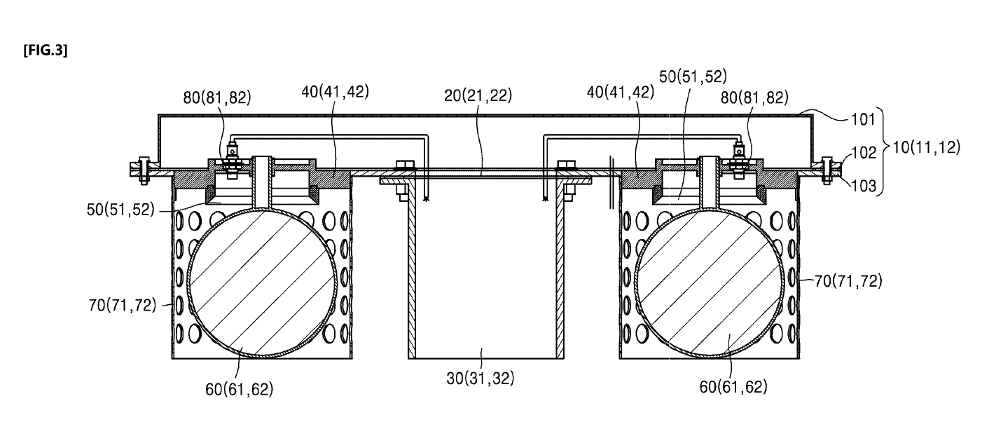

FIG. 1 is an exploded view of an air conditioning device according to one embodiment of the present invention, FIG. 2 is an internal view of the air conditioning device illustrated in FIG. 1, and FIG. 3 is a sectional view of the air conditioning device illustrated in FIG. 1. FIG. 2 illustrates the inside of the air conditioning device whose duct 10 is removed in a direction viewed from the top, and illustrates a section perpendicular to a line across the center of the duct 10 in the longitudinal direction of the duct 10. Referring to FIGS. 1 to 3, the air conditioning device according to the present embodiment is configured with the duct 10, a pipe gasket 20, a ventilation pipe 30, two guide members 40, two sealing packings 50, two floating bodies 60, and two perforated pipes 70. Hereinafter, an assembly process and a connection state of the aforementioned configuration elements will be described with reference to the exploded view illustrated in FIG. 1. The air conditioning device can be manufactured with a solid material which does not rust due to water. For example, the air conditioning device can be manufactured with stainless steel, aluminum alloy, reinforced plastic, or the like.

The two guide members 40, the two sealing packings 50, the two floating bodies 60, and the two perforated pipes 70 are elements which allows or does not allow air to flow through the ventilation pipe 30 depending on whether or not the air conditioning device illustrated in FIG. 1 are immersed in water at a height above a critical water level. As can be seen from the following description, it is possible for air to flow or not to flow through the ventilation pipe 30 by using one guide member 40, one sealing packing 50, one floating body 60, and one perforated pipe 70. However, ventilation ability through the elements decreases more than ventilation ability of the ventilation pipe 30 due to adoption of the structure for allowing or not allowing air to flow through the ventilation pipe 30.

In the present embodiment, in order to maintain the ventilation ability of the ventilation pipe 30, the two guide members 40, the two sealing packings 50, the two floating bodies 60, and the two perforated pipes 70 are used. Those skilled in the art to which the present embodiment belongs can understand that one guide member 40, one sealing packing 50, one floating body 60, and one perforated pipe 70 can be used and a great number of the guide member 40, the sealing packing 50, the floating body 60, and the perforated pipe 70 can be used so as to allow or not allow air to flow through the ventilation pipe 30. In a case where the object 100 is buried underground such that an upper surface of the object 100 is formed in the same height as a road surface, the air conditioning device can be installed in the same height as the road surface by mounting an air conditioning device of a shape illustrated in FIG. 1 on a recessed portion of a rectangular box shape formed in the outer surface of the object. In this case, a cover (not illustrated) covering the air conditioning device can be installed in the same height as the road surface so as to protect the air conditioning device. Accordingly, inconveniences of pedestrians due to a ground facility, vehicle accidents, and the like are eliminated.

The duct 10 is connected between an upper end of the ventilation pipe 30 and an upper end of the two perforated pipes 70 such that the ventilation pipe 30 and the two perforated pipes 70 communicate with each other. As illustrated in FIGS. 1 and 3, the duct 10 has a rectangular box shape in which omnidirectional side surfaces and an upper surface are closed and three openings are formed in a lower surface, an upper end of one ventilation pipe 30 is coupled to a peripheral surface of a central opening of the three openings in the lower surface in a sealed state thereby being able to be connected to the upper end of the ventilation pipe 30, and circumferences of the two openings on both ends are coupled to upper ends of the two perforated pipes 70 one-to-one thereby being able to be connected to the upper ends of the two perforated pipes 70. Referring to FIGS. 1 to 3, the duct 10 is configured with a duct upper plate 101, a duct gasket 102, and a duct lower plate 103.

The duct upper plate 101 has a rectangular box shape in which omnidirectional side surfaces and an upper surface are closed and a lower surface is opened, and a lower end thereof is coupled to the duct lower plate 103. The duct gasket 102 has a rectangular frame shape in which four straight frames are connected at right angles, and are inserted between the duct upper plate 101 and the duct lower plate 103 to seal a gap between the duct upper plate 101 and the duct lower plate 103. The duct lower plate 103 has a rectangular plate shape in which three circular openings are formed to be arranged in a longitudinal direction, an upper surface thereof is coupled to a lower end of the duct upper plate 101, a peripheral surface of the central opening of the three circular openings is coupled to the upper end of the ventilation pipe 30 in a sealed state, and upper ends of the two perforated pipes 70 come into close contact with peripheral surfaces of the two openings on both ends.

A combined slice with a predetermined width which outwardly extends from a lower end of the duct upper plate 101 is formed on a circumference of the lower end of the duct upper plate 101. As illustrated in FIGS. 1 to 3, multiple holes are formed at positions corresponding to each other in the combined slice of the lower end of the duct upper plate 101, the duct gasket 102, and the duct lower plate 103. The duct upper plate 101, the duct gasket 102, and the duct lower plate 103 are coupled to each other by making bolts sequentially pass through each hole of the combined slice of the lower end of the duct upper plate 101, the duct gasket 102, and the duct lower plate 103 and fastening the bolts with nuts. Accordingly, the duct upper plate 101 and the duct lower plate 103 can be coupled to each other in a state where a gap there between is sealed.

As such, since the upper end of the ventilation pipe 30 is coupled to the three openings of the lower surface of the duct 10 having a rectangular box shape in a sealed state and the upper ends of the two perforated pipes 70 are coupled therewith, rainwater falling to the air conditioning device illustrated in FIGS. 1 to 3 cannot be directly flowed into the ventilation pipe 30, and flows into the holes in lower portions of each perforated pipe 70 after hitting the closed upper surface of the duct 10, or directly flows into the holes in the lower portions of each perforated pipe 70. As illustrated in FIGS. 1 to 3, since upper portions of each perforated pipe 70 are covered by the duct 10, the rainwater cannot flow into the holes in the upper portions of each perforated pipe 70. Thus, in order for rainwater to flow into the ventilation pipe 30, the rainwater has to flow into the holes in the lower portions of each perforated pipe 70 and pass through an inner space of the duct 10 via a connection part of the duct 10. Since the inner space of the duct 10 is positioned at a higher portion than the lower portions of each perforated pipe 70, it is difficult for the rainwater flowed into the holes in the lower portions of each perforated pipe 70 to flow into the inner space of the duct 10. As a result, it is difficult for the rainwater falling to the air conditioning device illustrated in FIGS. 1 to 3 to flow into the ventilation pipe 30.

The pipe gasket 20 has a rectangular plate shape in which a circular opening is formed in the center thereof, and is inserted between the peripheral surface of the central opening of the duct 10 and the upper end of the ventilation pipe 30 to seal a gap between the peripheral surface of the central opening of the duct 10 and the upper end of the ventilation pipe 30. As illustrated in FIGS. 1 to 3, multiple holes are formed around the opening of the pipe gasket 20. Corresponding to this, a combined slice having the same shape as the pipe gasket 20 outwardly extending at right angles from the upper end of the ventilation pipe 30 is formed around the upper end of the ventilation pipe 30. Multiple holes are formed in positions corresponding to each other in the duct 10, the pipe gasket 20, and the combined slice of the upper end of the ventilation pipe 30. The duct 10, the pipe gasket 20, and the combined slice of the upper end of the ventilation pipe 30 are coupled to each other by making bolts sequentially pass through the holes of the duct 10, the pipe gasket 20, and the combined slice of the upper end of the ventilation pipe 30 and thereafter fastening the bolts with nuts. Accordingly, the duct 10 and the ventilation pipe 30 can be coupled to each other in a state where a gap there between is sealed.

The upper end of the ventilation pipe 30 is coupled to the peripheral surface of the central opening of the three openings in a sealed state on the outside of the object 100 to communicate with the inner space of the duct 10, and the lower end of the ventilation pipe 30 is coupled to a peripheral surface of a vent of the object 100 in a sealed state to communicate with the inner space of the object 100. As illustrated in FIGS. 1 and 3, omnidirectional side surfaces of the ventilation pipe 30 are closed, an upper surface and a lower surface thereof have an open circular shape, an upper end thereof can be coupled to the peripheral surface of the central opening of the duct 10 through an inserted pipe gasket 20 to be coupled to the central opening of the duct 10 in a sealed state, and a lower end thereof can be coupled to the peripheral surface of the vent of the object 100 by welding to be coupled to the peripheral surface of the vent of the object 100 in a sealed state. In a case where the lower end of the ventilation pipe 30 is coupled to the peripheral surface of the vent of the object 100 by welding, the ventilation pipe 30 is hard to be separated from the object 100. In this case, the air conditioning device according to the present embodiment can be replaced by replacing the remaining configuration elements except for the ventilation pipe 30.

Each of the two guide members 40 is installed on upper end sides of each perforated pipe 70 to provide paths in which protruding rods of each floating body 60 are inserted and can be slidably moved while air passes through, and guides vertical movements of each floating body 60. That is, the left guide member 40 is installed on the upper end side of the left perforated pipe 70 to provide the path in which the protruding rod of the floating body 60 is inserted and can be slidably moved while air passes through, and guides the vertical movement of the left floating body 60. In the same manner, the right guide member 40 is installed on the upper end side of the right perforated pipe 70 to provide the path in which the protruding rod of the floating body 60 is inserted and can be slidably moved while air passes through, and guides the vertical movement of the right floating body 60.

As such, since each floating body 60 has the protruding rods which are inserted in the paths of each guide member 40 to slidably move, the floating bodies 60 can vertically move exactly in proportion to the amount of water flowed into each perforated pipe 70 without shaking in the insides of each perforated pipe 70. As a result, in usual time, the connection parts between each perforated pipe 70 and the duct 10 are normally prevented from being sealed, and thereby, a period in which the inner space of the object 100 is ventilated with outside air can be secured as long as possible, and during rainfall, the connection parts between each perforated pipe 70 and the duct 10 are prevented from being opened, and thereby, flow of rainwater into the inner space of the object 100 can be certainly blocked.

As illustrated in FIGS. 1 to 3, each guide member 40 is configured with an outer frame of a disk shape in which an upper surface thereof is coupled to peripheral surfaces of each opening on both sides of the duct 10 in a sealed state and a path of a cylindrical shape is formed in the center thereof, and an inner frame of a cross spoke shape in which an end thereof is integrally connected to an inner surface of a ventilation path of the outer frame and a guide path of a cylindrical shape is formed in the center thereof. Upper surfaces of each guide member 40 are coupled to the peripheral surfaces of each opening on both sides of the duct 10 by welding, thereby, being able to be coupled to the peripheral surfaces of each opening on both sides of the duct 10 in a sealed state. As such, each guide member 70 guides vertical movements of each floating body 60 by making air pass through paths of a triangular prism shape which are formed by separating the inside of the ventilation path of a cylindrical shape of the outer frame by using the cross spoke shape of the inner frame, and by making the protruding rods of each floating body 60 slidably move on the inner surface of the guide path formed in the center of the inner frame in the inside of the ventilation path.

Each of the sealing packings 50 has a disk shape in which a circular opening is formed in the center thereof, and upper surfaces thereof are coupled to lower surfaces of the guide member 40 in a sealed state. That is, the upper surface of the left sealing packing 50 is coupled to the lower surface of the left guide member 40, and the upper surface of the right sealing packing 50 is coupled to the lower surface of the right guide member 40. Each sealing packing 50 can be manufactured with a waterproof material with elasticity, such as rubber, and can be coupled to the lower surfaces of each guide member 40, as the upper surface thereof adheres to the lower surfaces of each guide member 40 by using waterproof adhesive.

If the periphery of a hole of the sealing packing 50 formed of a rubber material is pressed by the circular outer surface of the floating body 60, the hole of the sealing packing 50 is sealed. Thus, waterproof ability of the sealing packing 50 is determined by force that the floating body 60 presses the sealing packing 50. The force that the floating body 60 presses the sealing packing 50 is determined by buoyancy acting on the floating body 60 by means of water in the perforated pipe 70, and thus, it is preferable that each floating body 60 has a maximum diameter in a state of being able to vertically move without friction with an inner surfaces of each perforated pipe 70.

Each of the two floating bodies 60 is positioned in the inner spaces of each perforated pipe 70, and vertically moves in the inner spaces of each perforated pipe 70, and vertically moves in the inner spaces of each perforated pipe 70 according to the amount of water flowed in through the holes of each perforated pipe 70. That is, the left floating body 60 is positioned at the inner space of the left perforated pipe 70, and vertically moves in the inner space of the left perforated pipe 70 according to the amount of water flowed in through the holes of left perforated pipe 70. In the same manner, the right floating body 60 is positioned at the inner space of the right perforated pipe 70, and vertically moves in the inner space of the right perforated pipe 70 according to the amount of water flowed in through the holes of right perforated pipe 70. As illustrated in FIGS. 1 to 3, each floating body 60 is lighter than buoyancy of water, and may be a circular ball on one side of which a protruding rod is formed. It is preferable that the floating body 60 is made of a material with smaller specific gravity than water so as to float on rainwater. For example, the floating body 60 can be made of plastic, styrofoam, rubber, or the like. In order to make weight of the floating body 60 much lighter, the inside of the floating body 60 may be empty.

The upper ends of each of the two perforated pipes 70 come into close contact with the peripheral surfaces of each opening on both ends of the lower surface of the duct 10, the lower ends thereof come into close contact with a flat outer surface of the object 100, and each of the two perforated pipes 70 is installed to be erected on the flat outer surface of the object 100 in parallel with the ventilation pipe 30. That is, the upper end of the left perforated pipe 70 comes into close contact with the peripheral surface of the opening on the left end of the lower surface of the duct 10, the lower end thereof comes into close contact with the flat outer surface of the object 100, and the left perforated pipe 70 is installed to be erected on the flat outer surface of the object 100 in parallel with the ventilation pipe 30. In the same manner, the upper end of the right perforated pipe 70 comes into close contact with the peripheral surface of the opening on the right end of the lower surface of the duct 10, the lower end thereof comes into close contact with the flat outer surface of the object 100, and thereby, the right perforated pipe 70 is installed to be erected on the flat outer surface of the object 100 in parallel with the ventilation pipe 30.

Since the perforated pipe 70 is not an element requiring waterproofing, the upper end and the lower end of the perforated pipe 70 need not be coupled to the duct 10 and the object 100 in a sealed state. Furthermore, there may be some gaps between the upper end of the perforated pipe 70 and the duct 10, and there may be some gaps between the lower end of the perforated pipe 70 and the outer surface of the object 100. In the present embodiment, the perforated pipe 70 simultaneously performs a role of guiding the floating body 60 to vertically move without shaking and a role of applying buoyancy to the floating body 60 by containing rainwater falling to the air conditioning device illustrated in FIG. 1. Since the air conditioning device has a very simple structure and can be easily separated from an object by employing the perforated pipe 70, it is very easy to replace, repair, and manage the air conditioning device.

As illustrated in FIGS. 1 to 3, multiple holes are formed in the omnidirectional side surfaces of each perforated pipe 70, the upper surface and the lower surface thereof have an open circular shape, each perforated pipe 70 is inserted between the peripheral surfaces of each opening on both ends of the lower surface of the duct 10 and the flat outer surface of the object 100, the upper ends of each perforated pipe 70 are fitted around the side surface of the lower portion of the guide member 40, and thereby, the upper ends thereof come into close contact with the peripheral surfaces of the openings on both ends of the lower surface of the duct 10 and at the same time, the lower ends thereof come into close contact with the flat outer surface of the object 100. As a result, each perforated pipe 70 can be installed to be erected on the flat outer surface of the object 100 in parallel with the ventilation pipe 30.

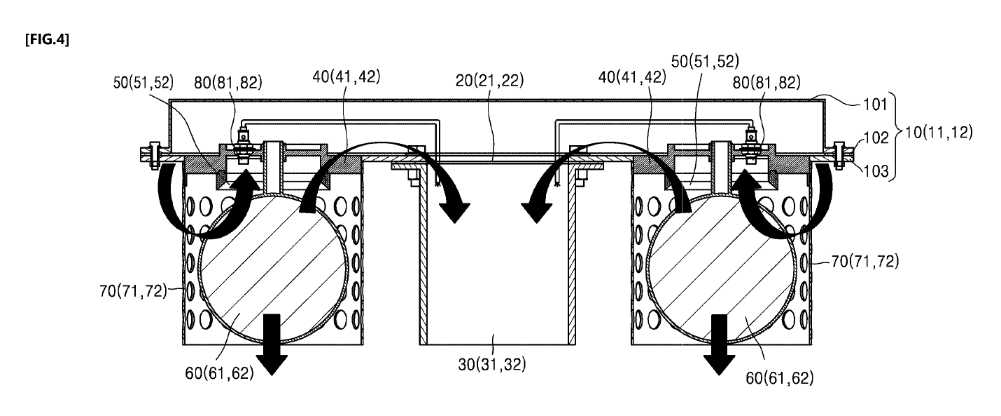

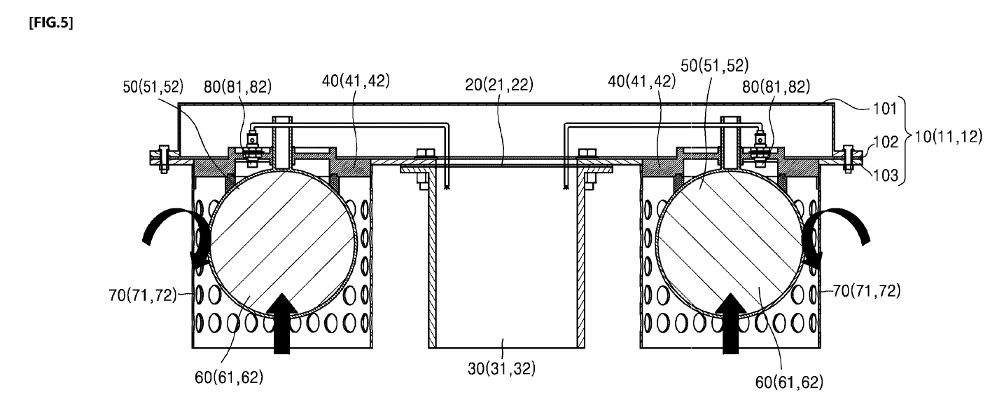

FIG. 4 is a view illustrating an operation that the air conditioning device illustrated in FIG. 1 ventilates the inner space of the object 100, and FIG. 5 is a view illustrating an operation that the air conditioning device illustrated in FIG. 1 closes the inner space of the object 100. Referring to FIGS. 4 and 5, the connection parts between each perforated pipe 70 and the duct 10 are opened or sealed by means of the vertical movements of each floating body 60 in the inner spaces of each perforated pipe 70, and thereby, the inner space of the object 100 is ventilated with outside air through the ventilation pipe 30 or the inner space of the object 100 is closed. That is, the connection part between the left perforated pipe 70 and the duct 10 is opened or sealed by means of the vertical movement of the left floating body 60 in the inner space of the left perforated pipe 70. In the same manner, the connection part between the right perforated pipe 70 and the duct 10 is opened or sealed by means of the vertical movement of the right floating body 60 in the inner space of the right perforated pipe 70.

Since each perforated pipe 70 and the duct 10 are connected to the guide member 40 coupled to the peripheral surfaces of each opening on both ends of the duct 10 in a sealed state, and the sealing packing 50 which are coupled to the lower surface of the guide member 40 in a sealed state, if the holes of each sealing packing 50 are opened or sealed, the connection parts between each perforated pipe 70 and the duct 10 are opened or sealed. As illustrated in FIGS. 4 and 5, if the connection part between the left perforated pipe 70 and the duct 10 and the connection part between the right perforated pipe 70 and the duct 10 are all sealed, the inner space of the object 100 can be closed, and if at least one of those is opened, the inner space of the object 100 can be ventilated.

As illustrated in FIG. 4, if each floating body 60 descends in the inner spaces of each perforated pipe 70 and thereby empty spaces are formed between peripheries of holes of each sealing packing 50 and circular outer surfaces of each floating body 60, the connection parts between each perforated pipe 70 and the duct 10 are opened and thereby the inner space of the object 100 can be ventilated with the outside air through the ventilation pipe 30. Since the floating body 60 ascends in proportion to the height of water flowed in through the holes of each perforated pipe 70, empty spaces are formed between the circular outer surfaces of each floating body 60 and the peripheries of the holes of each sealing packing 50 and thereby the connection parts between each perforated pipe 70 and the duct 10 are opened, when there is no water in the insides of each perforated pipe 70, or until water flows into the holes of each perforated pipe 70 and each perforated pipe 70 is immersed in the water at a height below a critical water level.

That is, when there is no water in the inside of the left perforated pipe 70, or until water flows into the holes of the left perforated pipe 70 and the left perforated pipe 70 is immersed in the water at a height below the critical water level, the empty space is formed between the circular outer surface of the left floating body 60 and the periphery of the hole of the left sealing packing 50 and thereby the connection parts between the left perforated pipe 70 and the duct 10 is opened. In the same manner, when there is no water in the inside of the right perforated pipe 70, or until water flows into the holes of the right perforated pipe 70 and the right perforated pipe 70 is immersed in the water at a height below the critical water level, the empty space is formed between the circular outer surface of the right floating body 60 and the periphery of the hole of the right sealing packing 50 and thereby the connection parts between the right perforated pipe 70 and the duct 10 is opened.

As illustrated in FIG. 5, if each floating body 60 ascends in the inner spaces of each perforated pipe 70 and thereby the peripheries of the holes of each sealing packing 50 are pressed by the circular outer surface of each floating body 60, the connection parts between each perforated pipe 70 and the duct 10 are sealed and thereby air cannot flow through the ventilation pipe 30. As a result, the inner space of the object 100 is closed. If water flows into the holes of each perforated pipe 70 and thereby each perforated pipe 70 is immersed in the water at a height above the critical water level, each floating body 60 ascends in the inner spaces of each perforated pipe 70 until the circular outer surfaces of each floating body 60 press the peripheries of the holes of each sealing packing 50, and as a result, the connection parts between each perforated pipe 70 and the duct 10 are sealed. That is, if the left perforated pipe 70 is immersed in the water at a height above the critical water level, the circular outer surface of the left floating body 60 which ascends at a height proportional to a level of the water flowed in through the holes of the left perforated pipe 70 presses the periphery of the hole of the left sealing packing 50, and thereby, the connection parts between the left perforated pipe 70 and the duct 10 is sealed. In the same manner, if the right perforated pipe 70 is immersed in the water at a height above the critical water level, the circular outer surface of the right floating body 60 which ascends at a height proportional to a level of the water flowed in through the holes of the right perforated pipe 70 presses the periphery of the hole of the right sealing packing 50, and thereby, the connection parts between the right perforated pipe 70 and the duct 10 is sealed.

After each perforated pipe 70 is immersed in the water at a height above the critical water level, if the water flows out of the holes of each perforated pipe 70 and thereby each perforated pipe 70 is immersed in water at a height below the critical water level, each floating body 60 is separated from the periphery of the hole of the sealing packing 50 to descend, and thereby, an empty is formed between the circular outer surfaces of each floating body 60 and the peripheries of the holes of each sealing packing 50 and the connection parts between each perforated pipe 70 and the duct 10 are opened. Thus, air conditioning device illustrated in FIG. 1 can seal the inner space of the object 100 only during the rain, and can ventilate the inner space of the object 100 in usual time. The inner space of the object 100 is waterproof, and temperature, humidity, and the like of the inner space can be automatically maintained in a state similar to the outside through ventilation with outside air, by the air conditioning device.

That is, the air conditioning device according to the present embodiment includes an air conditioning function of cooling an apparatus installed in the inner space of the object 100 by means of natural convection and of maintaining humidity and the like in a state similar to the outside by ventilating the inner space of the object 100 with the outside air in usual time, and a waterproof function of preventing the apparatus installed in the inner space of the object 100 from flooding by closing the inner space of the object 100 when water flows into the air conditioning device due to rainfall or the like. As such, as the air conditioning device according to the present embodiment includes the waterproof function in addition to the air conditioning function, air conditioning and waterproofing of the inner space of the object can be simultaneously performed at a very low cost without installing a separate ground facility for waterproofing the inner space of the object. For example, if electrical equipment is installed in the inner space of the object 100, not only a failure rate of the electrical equipment due to overheat and excessive moisture can be greatly reduced, but also a life span of the electrical equipment can be extended since the electrical equipment operates in an optimal state.

As described above, if at least one of the connection part between the left perforated pipe 70 and the duct 10 and the connection part between the right perforated pipe 70 and the duct 10 is opened, the inner space of the object 100 can be ventilated. Thus, in order to close the inner space of the object 100, both the connection part between the left perforated pipe 70 and the duct 10 and the connection part between the right perforated pipe 70 and the duct 10 have to be opened. Meanwhile, if the left perforated pipe 70 and the right perforated pipe 70 are installed on a horizontal plane, left perforated pipe 70 and the right perforated pipe 70 are immersed in water at the same height, and as a result, the connection part between left perforated pipe 70 and the duct 10 and the connection part between the right perforated pipe 70 and the duct 10 are simultaneously opened or sealed. Thus, in order to more accurately control the sealing of the connection part between left perforated pipe 70 and the duct 10 and the connection part between the right perforated pipe 70 and the duct 10, it is preferable that the left perforated pipe 70 and the right perforated pipe 70 are installed in a horizontal plane.

According to the present embodiment, the circular outer surfaces of each floating body 60 press the peripheries of the holes of each sealing packing 50 installed in the connection parts between each perforated pipe 70 and the duct 10, and thereby, the connection parts between each floating body 60 and the duct 10 are sealed. Accordingly, the holes of each sealing packing 50 are sealed in a state where each floating body 60 ascends by a length less than half the diameter of the floating body 60. However, if sizes of each floating body 60 are small, each floating body 60 can be momentarily immersed in water which rapidly flows in through the holes of each perforated pipe 70. If each floating body 60 is immersed in rainwater, the rainwater can flow into the ventilation pipe 30. The more the sizes of each floating body 60 increase, the more the possibility that each floating body 60 is immersed in the water flowing into the holes of each perforated pipe 70 decreases.

In the present embodiment, each floating body 60 has a larger diameter than a maximum diameter of a floating body which can be immersed in water flowing into the holes of each perforated pipe 70 at a maximum flow rate. Thus, even if the water flows into the holes of each perforated pipe 70 at a maximum flow rate, each floating body 60 cannot be immersed in the water in each perforated pipe 70. Here, the maximum flow rate of the water flowing in through the holes of each perforated pipe 70 means a maximum flow rate of rainwater flowing in through the holes of each perforated pipe 70 due to rainfall at a place where the air conditioning device illustrated in FIGS. 1 to 3 is installed. As described above, it is preferable that each floating body 60 has a maximum diameter in a state of being able to vertically move without friction with the inner surface of each perforated pipe 70. That is, the diameters of each floating body 60 are similar to inner diameters of each perforated pipe 70.

Since not only the hole of the sealing packing 50 is sealed in as state where the floating body 60 ascends at a height less than half the diameter of the floating body 60 but also the diameter of the floating body 60 is similar to the inner diameter of the perforated pipe 70, a height of the water flowed into the perforated pipe 70 ascends at a height less than half the diameter of the floating body 60 until the hole of the sealing packing 50 is sealed, and thereby, the water flowed into the perforated pipe 70 is blocked by a portion corresponding to half the diameter of the floating body 60 having a diameter similar to the inner diameter of the perforated pipe 70, that is, by the widest portion. As a result, there is no possibility that water flows in from the holes in the upper portion of the perforated pipe 70 positioned at a height above half the diameter of the floating body 60. Furthermore, since the inner space of the duct 10 is positioned at a place higher than the lower portions of each perforated pipe 70, inflow of rainwater from the ventilation pipe 30 is perfectly blocked.

If the holes of each perforated pipe 70 are large, water quickly flows into each perforated pipe 70, and thereby, the floating body 60 ascends as soon as it begins to rain. Accordingly, the connection parts between each perforated pipe 70 and the duct 10 can be immediately sealed. However, if the size of the floating body 60 is excessively small compared with the size of the holes of each perforated pipe 70, the floating body 60 is immersed in water flowing into each perforated pipe 70 and thereby there is a possibility that the water flows into the ventilation pipe 30. Meanwhile, if the holes of each perforated pipe 70 are small, the water slowly flows into each perforated pipe 70, and thus, there is little possibility that the floating body 60 is immersed in the water flowing into each perforated pipe 70. However, if the sizes of the holes of each perforated pipe 70 are excessively small compared with the size of the floating body 60, the floating body 60 ascends slowly and after a certain amount of time passes since it begins to rain, the connection parts between each perforated pipe 70 and the duct 10 are sealed, and thereby, reactivity of sealing of the connection part between each perforated pipe 70 and the duct 10 can be reduced. It is preferable that the holes of each perforated pipe 70 have an optimal size by bridging the reactivity of sealing of the connection part between each perforated pipe 70 and the duct 10 and flooding risk of the floating body 60.

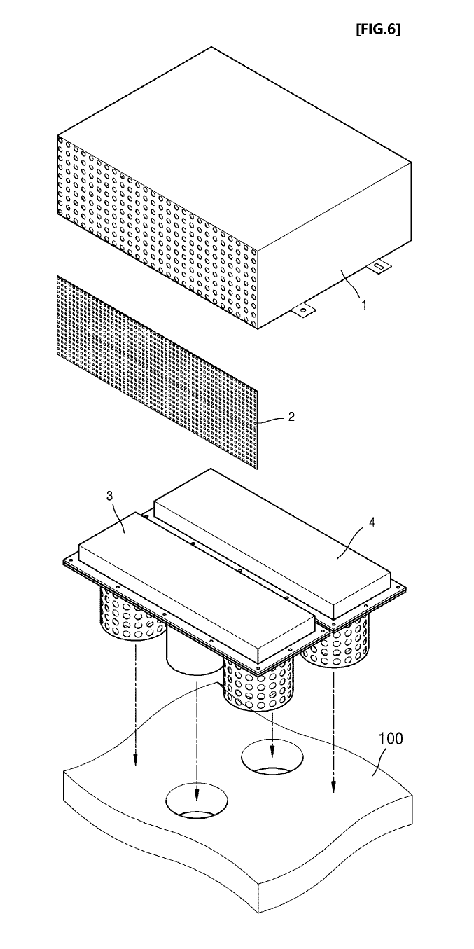

FIG. 6 is an exploded view of an air conditioning device according to another embodiment of the present invention. Referring to FIG. 6, the air conditioning device according to the present embodiment is configured with a housing 1, a filter 2, a supply unit 3, and an exhaust unit 4. Hereinafter, an assembly process and a connection state of the aforementioned configuration elements will be described with reference to the exploded view illustrated in FIG. 6. In the embodiment illustrated in FIG. 1, the inner space of the object 100 is ventilated or closed by using the ventilation pipe 30 in accordance with the amount of water flowing into the air conditioning device. However, if air circulates between the inside and the outside of the object 100 through one ventilation pipe 30, a flow of the air flowing into the ventilation pipe 30 can collide with a flow of the air flowing out of the ventilation pipe 30, and thus, a smooth air circulation between the inner space and an outer space of the object 100 may not be performed. Particularly, the air conditioning device can forcibly circulate the air between the inside and the outside of the object 100 by using a fan in accordance with temperature of the inner space of the object 100.

In the embodiment illustrated in FIG. 6, in order to perform the smooth air circulation between the inner space and the outer space of the object 100 and enable a forcible air circulation, a supply side which enables air to flow into the inner space of the object 100 from the outer space of the object 100 is configured to be separated from an exhaust side which enables the air to flow out from the inner space of the object 100 to the outer space of the object 100, and temperature and humidity of the inner space of the object 100 can be maintained in approximately the same manner as the outside. Accordingly, the object 100 includes a supply hole through which air flows into the inner space of the object 100 from the outer space of the object 100, and an exhaust hole through which the air flows out from the inner space of the object 100 to the outer space of the object 100. Corresponding to the supply hole and the exhaust hole of the object 100, the respective configuration elements of the embodiment illustrated in FIGS. 1 to 3 are configured to be separated into configuration elements which are used for the supply side and configuration elements which are used for the exhaust side.

For example, the ventilation pipe 30 is configured to be separated into a supply pipe 31 whose lower end is coupled to a peripheral surface of the supply hole of the object 100 in a sealed state to communicate with the inner space of the object 100, and an exhaust pipe 32 whose lower end is coupled to a peripheral surface of the exhaust hole of the object 100 in a sealed state to communicate with the inner space of the object 100. In addition, the perforated pipe 70 is configured to be separated into at least one supply perforated pipe 71 which is installed to be erected on the flat outer surface of the object 100 in parallel with the supply pipe 31, and at least one exhaust perforated pipe 72 which is installed to be erected on the flat outer surface of the object 100 in parallel with the exhaust pipe 32. The duct 10 is configured to be separated into a supply duct 11 which is connected between an upper end of the supply pipe 31 and an upper end of the supply perforated pipe 71 such that the supply pipe 31 communicates with the supply perforated pipe 71, and an exhaust duct 12 which is connected between an upper end of the exhaust pipe 32 and an upper end of the exhaust perforated pipe 72 such that the exhaust pipe 32 communicates with the exhaust perforated pipe 72. In the same manner, the remaining configuration elements are configured to be separated into the configuration elements which are used for the supply side and the configuration elements which are used for the exhaust side.

The housing 1 is mounted on the flat outer surface of the object 100 and covers the supply unit 3 and the exhaust unit 4 in a non-sealed state to protect the supply unit 3 and the exhaust unit 4. Multiple holes are formed in a part of the housing 1, and thereby, smoother ventilation can be performed and at the same time, a speed of water flowing into the supply unit 3 and the exhaust unit 4 can be adjusted. As illustrated in FIG. 6, the multiple holes are formed only in a partial side surface of four side surfaces of the housing 1, and the remaining two side surfaces and an upper surface are closed, and a lower surface has an open rectangular box shape and is coupled to the flat outer surface of the object 100 such that the supply unit 3 and the exhaust unit 4 are positioned in the inner space.

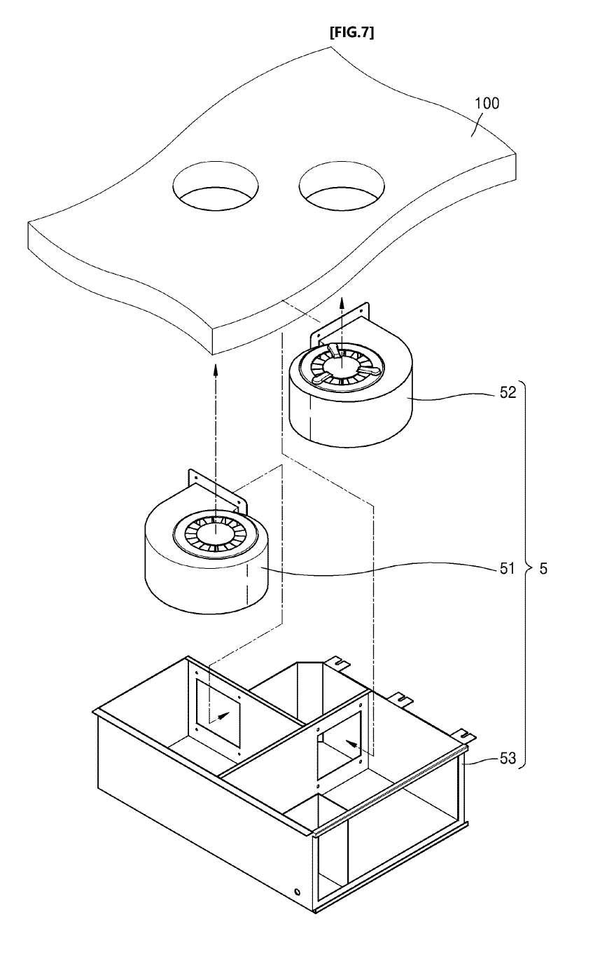

As illustrated in FIG. 7, multiple combined slices which are used for coupling with the object 100 are formed in lower ends of the side surfaces of the housing 1. Nut-shaped grooves are formed on the flat outer surface of the object 100, and holes corresponding to the grooves on the flat outer surface of the object 100 are formed in the combined slices of the housing 1. After bolts respectively pass through each hole of the combined slices of the housing 1, the bolts are respectively fastened with each groove of the flat outer surface of the object 100, and thereby, the housing 1 can be coupled to the flat outer surface of the object 100. In order to perform smoother ventilation through the housing 1, a part or all of the four side surfaces of the housing 1 may be perforated surfaces in which multiple circular holes for ventilation are formed. According to the present embodiment, two side surfaces, which face each other, of the four side surfaces of the housing 1 are perforated surfaces.

The filter 2 is attached to an outer side or an inner side of the perforated surface of the housing 1, and filters substances other air and water from substances flowing into the air conditioning device. The filter 2 is configured with a filter net of a rectangular plate shape through which air and water can flow in or out, and a rectangular frame of a shape which encloses the filter net. The filter net is press-fitted into the rectangular frame to be fixed. The filter net can be manufactured with a textile material. Since the housing 1 is generally manufactured with a metal material, it is difficult to form the holes which enable air to pass through and does not enable fine substance such as soil erosion substance to pass through and the housing 1 cannot be replaced frequently. The filter 2 filters the fine substance, and thereby, it is possible to prevent the air conditioning device from being blocked due to sedimentation of the fine substance, and to frequently replace the filter.

In the present embodiment each of the supply unit 3 and the exhaust unit 4 has the same configuration as in the embodiment illustrated in FIGS. 1 to 3. Hereinafter, each configuration of the supply unit 3 and the exhaust unit 4 will be described with reference to FIGS. 1 to 3. The supply unit 3 is configured with a supply duct 11, a pipe gasket 21, a supply pipe 31, two guide members 41, two sealing packings 51, two floating bodies 61, and two supply perforated pipes 71. The duct 10, the pipe gasket 20, the ventilation pipe 30, the two guide members 40, the two sealing packings 50, the two floating bodies 60, and the two perforated pipes 70 perform both an supply operation and an exhaust operation, but the supply duct 11, the pipe gasket 21, the supply pipe 31, the two guide members 41, the two sealing packings 51, the two floating bodies 61, and the two supply perforated pipes 71 perform only the supply operation. Except for the aforementioned difference, configurations of the two embodiments are the same except for the aforementioned difference, and thus, hereinafter, only a basic configuration relating to the supply operation will be described, and the remaining configuration will be replaced with the aforementioned description which is made with reference to FIGS. 1 to 3.

The supply duct 11 is connected between an upper end of the supply pipe 31 and upper ends of the two supply perforated pipes 71 such that the supply pipe 31 communicates with the two supply perforated pipes 71. The pipe gasket 21 has a rectangular plate shape in which a circular opening is formed in the center thereof, is inserted between a peripheral surface of the central opening of the supply duct 11 and the upper end of the supply pipe 31, thereby, sealing a gap between the peripheral surface of the central opening of the supply duct 11 and the upper end of the supply pipe 31. The upper end of the supply pipe 31 is coupled to the peripheral surface of a central opening of three openings of the supply duct 11 in a sealed state in the outside of the object 100 and thereby the supply pipe 31 communicates with an inner space of the supply duct 11, and a lower end of the supply pipe 31 is coupled to a peripheral surface of a supply hole of the object 100 in a sealed state and thereby the supply pipe 31 communicates with the inner space of the object 100.

Each of the two guide members 41 is installed on upper end sides of each supply perforated pipe 71 to provide paths in which protruding rods of each floating body 61 are inserted and can be slidably moved while air passes through, and guides vertical movements of each floating body 61. Each of the sealing packings 51 has a disk shape in which a circular opening is formed in the center thereof, and upper surfaces thereof are coupled to lower surfaces of each guide member 41. If the peripheries of holes of each sealing packing 51 are pressed by the circular outer surfaces of each floating body 61, the holes of each sealing packing 51 are sealed. Each of the two floating bodies 61 is positioned in the inner spaces of each supply perforated pipe 71, and vertically moves in the inner spaces of each supply perforated pipe 71 according to the amount of water flowed in through the holes of each supply perforated pipe 71. The upper ends of each of the two perforated pipes 71 come into close contact with the peripheral surfaces of each opening on both ends of the lower surface of the supply duct 11, the lower ends thereof come into close contact with a flat outer surface of the object 100, and each of the two supply perforated pipes 71 is installed to be erected on the flat outer surface of the object 100 in parallel with the supply pipe 31.

Connection parts between each supply perforated pipe 71 and the supply duct 11 are opened or sealed by means of vertical movements of each floating body 61 in the inner spaces of each supply perforated pipe 71, and thereby, air is flowed into the inner space of the object 100 from the outside through the supply pipe 31 or inflow of the air is blocked. That is, if each floating body 61 descends in the inner spaces of each supply perforated pipe 71 and thereby empty spaces are formed between peripheries of holes of each sealing packing 51 and circular outer surfaces of each floating body 61, the connection parts between each supply perforated pipe 71 and the supply duct 11 are opened and thereby air flows into the inner space of the object 100 through the supply pipe 31. If each floating body 61 ascends in the inner spaces of each supply perforated pipe 71 and thereby the peripheries of the holes of each sealing packing 51 are pressed by the circular outer surfaces of each floating body 61, the connection parts between each supply perforated pipe 71 and the supply duct 11 are sealed and thereby inflow of air through the supply pipe 31 is blocked.

Referring to FIGS. 1 to 3, the exhaust unit 4 is configured with an exhaust duct 12, a pipe gasket 22, an exhaust pipe 32, two guide members 42, two sealing packings 52, two floating bodies 62, and the two exhaust perforated pipes 72. The duct 10, the pipe gasket 20, the ventilation pipe 30, the two guide members 40, the two sealing packings 50, the two floating bodies 60, and the two perforated pipes 70 perform both an supply operation and an exhaust operation, but the exhaust duct 12, the pipe gasket 22, the exhaust pipe 32, the two guide members 42, the two sealing packings 52, the two floating bodies 62, and the two exhaust perforated pipes 72 perform only the exhaust operation. Except for the aforementioned difference, configurations of the two embodiments are the same, and thus, hereinafter, only a basic configuration relating to the exhaust operation will be described, and the remaining configuration will be replaced with the aforementioned description which is made with reference to FIGS. 1 to 3.

The exhaust duct 12 is connected between an upper end of the exhaust pipe 32 and upper ends of the two exhaust perforated pipes 72 such that the exhaust pipe 32 communicates with the two exhaust perforated pipes 72. The pipe gasket 22 has a rectangular plate shape in which a circular opening is formed in the center thereof, is inserted between a peripheral surface of the central opening of the exhaust duct 12 and the upper end of the exhaust pipe 32, thereby, sealing a gap between the peripheral surface of the central opening of the exhaust duct 12 and the upper end of the exhaust pipe 32. The upper end of the exhaust pipe 32 is coupled to the peripheral surface of a central opening of three openings of the exhaust duct 12 in a sealed state in the outside of the object 100 and thereby the exhaust pipe 32 communicates with an inner space of the exhaust duct 12, and a lower end of the exhaust pipe 32 is coupled to a peripheral surface of an exhaust hole of the object 100 in a sealed state and thereby the exhaust pipe 32 communicates with the inner space of the object 100.

Each of the two guide members 42 is installed on upper end sides of each exhaust perforated pipe 72 to provide paths in which protruding rods of each floating body 62 are inserted and can be slidably moved while air passes through, and guides vertical movements of each floating body 62. Each of the sealing packings 52 has a disk shape in which a circular opening is formed in the center thereof, and upper surfaces thereof are coupled to lower surfaces of each guide member 42. If the peripheries of holes of each sealing packing 52 are pressed by the circular outer surfaces of each floating body 62, the holes of each sealing packing 52 are sealed. Each of the two floating bodies 62 is positioned in the inner spaces of each exhaust perforated pipe 72, and vertically moves in the inner spaces of each exhaust perforated pipe 72 according to the amount of water flowed in through the holes of each exhaust perforated pipe 72. The upper ends of each of the two perforated pipes 72 come into close contact with the peripheral surfaces of each opening on both ends of the lower surface of the exhaust duct 12, the lower ends thereof come into close contact with a flat outer surface of the object 100, and each of the two exhaust perforated pipes 72 is installed to be erected on the flat outer surface of the object 100 in parallel with the exhaust pipe 32.

Connection parts between each exhaust perforated pipe 72 and the exhaust duct 12 are opened or sealed by means of vertical movements of each floating body 62 in the inner spaces of each exhaust perforated pipe 72, and thereby, air is flowed into the inner space of the object 100 from the outside through the exhaust pipe 32 or inflow of the air is blocked. That is, if each floating body 62 descends in the inner spaces of each exhaust perforated pipe 72 and thereby empty spaces are formed between peripheries of holes of each sealing packing 52 and circular outer surfaces of each floating body 62, the connection parts between each exhaust perforated pipe 72 and the exhaust duct 12 are opened and thereby air flows into the inner space of the object 100 through the exhaust pipe 32. If each floating body 62 ascends in the inner spaces of each exhaust perforated pipe 72 and thereby the peripheries of the holes of each sealing packing 52 are pressed by the circular outer surfaces of each floating body 62, the connection parts between each exhaust perforated pipe 72 and the exhaust duct 12 are sealed and thereby inflow of air through the exhaust pipe 32 is blocked.

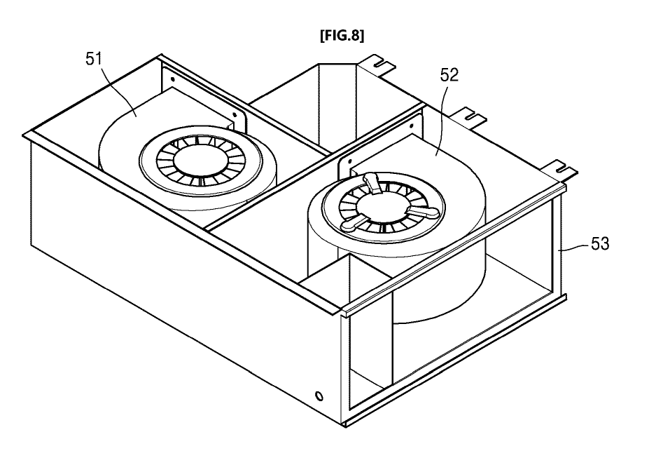

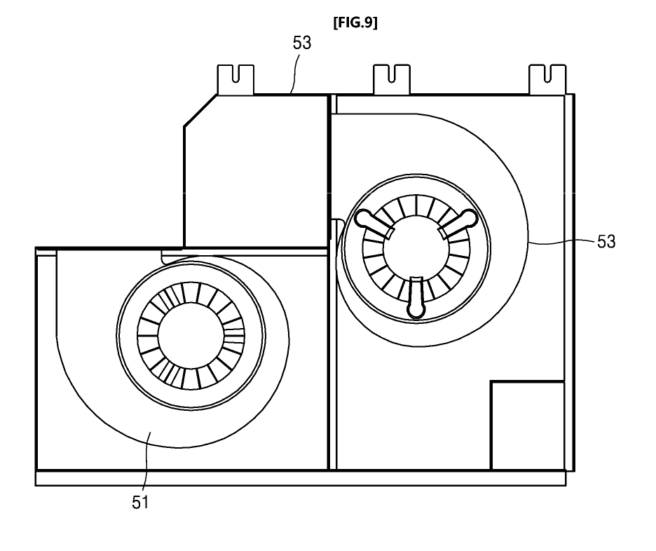

FIG. 7 is an exploded view of a fan 5 of an air conditioning device according to still another embodiment of the present invention, FIG. 8 is a perspective view of the fan 5 illustrated in FIG. 7, and FIG. 9 is a plan view of the fan 5 illustrated in FIG. 7. Referring to FIGS. 6 and 7, the air conditioning device according to the present embodiment is configured with the housing 1, the filter 2, the supply unit 3, the exhaust unit 4, the fan 5, a proximity sensor 80, a temperature sensor, and a control unit. That is, the air conditioning device according to the present embodiment further includes the fan 5, the proximity sensor 80, the temperature sensor, and the control unit in addition to the configuration elements of the air conditioning device described above so as to perform forcible air circulation in the inner space of the object 100. As illustrated in FIG. 6, the proximity sensor 80 is installed in the inside of the air conditioning device illustrated in FIG. 6. As illustrated in FIG. 7, the fan 5 is installed in an inner surface of the object 100.

The temperature sensor and the control unit are not illustrated in FIGS. 7 to 9, but are installed in the inner space of the object 100. The proximity sensor 80 is installed on the upper end sides of each of the perforated pipes 71 and 72, and detects a degree of proximity between each floating body 60. The temperature sensor detects temperature of the inner space of the object 100. The control unit can be realized by a micro computer. As such, the temperature sensor and the control unit are not elements with certain technical characteristics in an external or internal structure thereof, and the present embodiment can be understood only by description on this, and thus, the temperature sensor and the control unit are omitted in FIGS. 7 and 9 so as to avoid complex drawings.

The fan 5 is coupled to a peripheral surface of the supply hole of the object 100 in the inside of the object 100 and absorbs air from the outside of the object 100 through the supply pipe 31, and is coupled to a peripheral surface of the exhaust hole of the object 100 in the inside of the object 100 and exhausts air to the outside of the object 100 through the exhaust pipe 32, under control of the control unit, and thereby, the air absorbed through the supply pipe 31 is forcibly circulated in the inner space of the object 100 and is exhausted through the exhaust pipe 32. Since the inner space of the object 100 is closed by the supply unit 3 and the exhaust unit 4 during rainfall, the fan 5 need not be coupled to the peripheral surface of the supply hole of the object 100 in a sealed state. However, the larger the gap between the fan 5 and the peripheral surface of the supply hole of the object 100 is, the more the efficiency of the fan 5 decreases, and thus, it is preferable that the fan 5 come into close contact with the peripheral surface of the supply hole of the object 100 if possible.

Referring to FIG. 7, the fan 5 is configured with a supply fan 51, an exhaust fan 52, and a fan case 53. The supply fan 51 is coupled to the peripheral surface of the supply hole of the object 100 in a sealed state or a non-sealed state in the inside of the object 100, and absorbs air from the outside of the object 100 through the supply pipe 31 by using a blade rotating in a direction absorbing the air from the supply pipe 31 and exhausts the air to the inner space of the object 100. The supply fan 51 can be coupled to the peripheral surface of the supply hole of the object 100 in a sealed state so as to increase efficiency thereof. The exhaust fan 52 is coupled to the peripheral surface of the exhaust hole of the object 100 in a non-sealed state in the inside of the object 100, and absorbs air from the inner space of the object 100 by using a blade rotating in a direction exhausting the air to the exhaust pipe 32 and exhausts the air to the outside of the object 100 through the exhaust pipe 32. The fan case 53 is coupled to the inner surface of the object 100 in a state where the supply fan 51 and the exhaust fan 52 are contained, such that the respective fans 51 and 52 can be coupled to the peripheral surface of the supply hole of the object 100 and the peripheral surface of the exhaust hole of the object 100.

As will be described below, drives of the supply fan 51 and the exhaust fan 52 during rainfall are stopped under control of the control unit. The supply fan 51 and the exhaust fan 52 can be driven due to various reasons such as failure of the control unit even during rainfall. Since the drive of the supply fan 51 is performed in a direction in which the floating body 61 ascends in the inside of the two supply perforated pipes 71, problems do not occur except for an increase of temperature of a motor in the supply fan 51 and unnecessary power consumption, even if the supply fan 51 is abnormally driven. Meanwhile, since the drive of the exhaust fan 52 is performed in a direction in which the floating body 61 descends in the inside of the two supply perforated pipes 71, if the exhaust fan 52 is abnormally driven, in addition to the aforementioned problem, a problem can occur in which the floating body 62 descends by means of the drive of the exhaust fan 52, a gap occurs between the circular outer surface of the two floating bodies 62 and the periphery of the hole of the exhaust fan 52, and thereby, rainwater flows into the hole of the exhaust fan 52.

As illustrated in FIG. 7, a gap which enables wind power smaller than buoyance of each floating body 62 occurring due to water flowed in through the holes of each exhaust perforated pipe 72 to act on each floating body 62 positioned in the inner space of each exhaust perforated pipe 72 is formed between the exhaust fan 52 and the peripheral surface of the exhaust hole of the object 100. In more detail, three straight protrusions are formed at intervals of 120 degrees on the periphery surface of the exhaust hole of the exhaust fan 52, the exhaust fan 52 and the periphery surface of the exhaust hole of the object 100 are coupled to each other in a state where the protrusions are inserted, and as a result, a gap occurs between the exhaust fan 52 and the periphery surface of the exhaust hole of the object 100. By appropriately adjusting heights of the straight protrusions, maximum efficiency of the exhaust fan 52 is ensured, and the wind power smaller than the buoyance of each floating body 62 occurring due to the water flowed in through the holes of each exhaust perforated pipes 72 can act on each floating body 62 positioned in the inner space of each exhaust perforated pipe 72.

As such, since the wind power smaller than the buoyance of each floating body 62 occurring due to the water flowed in through the holes of each exhaust perforated pipes 72 acts on each floating body 62 positioned in the inner space of each exhaust perforated pipe 72, even if the exhaust fan 52 is driven in a state where the circular outer surface of each floating body 62 presses the periphery of the hole of each sealing packing 52, air exhausted from the exhaust fan 52 flows out through the gap between the exhaust fan 52 and the periphery surface of the exhaust hole of the object 100. That is, each floating body 62 does not descend by means of the drive of the exhaust fan 52 in a state where the circular outer surface of each floating body 62 presses the periphery of the hole of each sealing packing 52, and as a result, a gap does not occur between the circular outer surface of the floating body 62 and the periphery of the hole of the sealing packing 52.

The control unit measures at least one of positions of each floating body 61 in the inside of each supply perforated pipe 71 and positions of each floating body 62 in the inside of each exhaust perforated pipe 72, and controls the drive of the fan 5 depending on whether or not the measurement result indicates at least one sealing of the connection parts between each supply perforated pipe 71 and the supply duct 11 and the connection parts between each exhaust perforated pipe 72 and the exhaust duct 12. That is, if the two supply perforated pipes 71 and the two exhaust perforated pipes 72 are installed on a horizontal plane, the two supply perforated pipes 71 and the two exhaust perforated pipes 72 are immersed in water at the same height, and as a result, the connection parts between each supply perforated pipe 71 and the supply duct 11 and the connection parts between each exhaust perforated pipe 72 and the exhaust duct 12 are simultaneously opened or sealed.

In this case, the control unit measures any one of the positions of each floating body 61 in the inner space of each supply perforated pipe 71 and positions of each floating body 62 in the inner space of each exhaust perforated pipe 72, and can control the drive of the fan 5 by determining that the connection parts between each supply perforated pipe 71 and the supply duct 11 and the connection parts between each exhaust perforated pipe 72 and the exhaust duct 12 are all sealed, depending on whether or not the measurement result indicates any one sealing of the connection parts between each supply perforated pipe 71 and the supply duct 11 and the connection parts between each exhaust perforated pipe 72 and the exhaust duct 12. Otherwise, the control unit measures the positions of each floating body 61 in the inner space of each supply perforated pipe 71, and can control the drive of the supply fan 51 depending on whether or not the measurement result indicates sealing of the connection parts between each supply perforated pipe 71 and the supply duct 11, and measures the positions of each floating body 62 in the inner space of each exhaust perforated pipe 72, and can control the drive of the exhaust fan 52 depending on whether or not the measurement result indicates sealing of the connection parts between each exhaust perforated pipe 72 and the exhaust duct 12.

The proximity sensor 80 is installed on at least one of the upper end sides of each supply perforated pipe 71 and the upper end sides of each exhaust perforated pipe 72, and detects degrees of proximity of each floating body 61 vertically moving in the inner space of each supply perforated pipe 71 and detects degrees of proximity of each floating body 62 vertically moving in the inner space of each exhaust perforated pipe 72. As illustrated in FIGS. 1 to 3, the proximity sensor 80 is configured to be separated into a proximity sensor 81 which is installed on the upper end sides of each supply perforated pipe 71 and a proximity sensor 82 which is installed on the upper end sides of each exhaust perforated pipe 72. That is, the proximity sensor 81 is inserted in the guide members 41 installed on the upper end sides of each supply perforated pipe 71, and detects proximity distances between the proximity sensor 81 and each floating body 61. In the same manner, the proximity sensor 82 is inserted in the guide members 42 installed on the upper end sides of each exhaust perforated pipe 72, and detects proximity distances between the proximity sensor 82 and each floating body 62.

The control unit measures degrees of proximity of each floating body 61 vertically moving in the inner spaces of each supply perforated pipe 71, that is, positions of each floating body 61 in the inner spaces of each supply perforated pipe 71 from the proximity distance detected by the proximity sensor 81, and measures degrees of proximity of each floating body 62 vertically moving in the inner spaces of each exhaust perforated pipe 72, that is, positions of each floating body 62 in the inner spaces of each exhaust perforated pipe 72 from the proximity distance detected by the proximity sensor 82. Whether or not the connection parts between each supply perforated pipe 71, and the supply duct 11 are sealed and whether or not the connection parts between each exhaust perforated pipe 72 and the exhaust duct 12 are sealed can be detected by using various methods such as a method of measuring the amount of water flowed into the air conditioning device.

According to the present embodiment, since the connection parts between each of the perforated pipes 71 and 72 and the ducts 11 and 12 are sealed as the circular outer surfaces of each of the floating bodies 61 and 62 press the peripheries of the holes of each of the sealing packings 51 and 52, the positions of each of the floating bodies 61 and 62 in the inner spaces of each of the perforated pipes 71 and 72 can indicate without an error whether or not the connection parts between each of the perforated pipes 71 and 72 and the ducts 11 and 12. Particularly, the proximity sensors 81 and 82 can measure very accurately degrees of proximity of each of the floating bodies 61 and 62 without contact. Although various detection methods can be used, the aforementioned detection method can detect very accurately whether or not the connection parts between each supply perforated pipe 71 and the supply duct 11 are sealed and whether or not the connection parts between each exhaust perforated pipe 72 and the exhaust duct 12 are sealed.

In more detail, if the measurement result indicates at least one sealing of the connection parts between each supply perforated pipe 71 and the supply duct 11 and the connection parts between each exhaust perforated pipe 72 and the exhaust duct 12, the control unit stops drives of the supply fan 51 and the exhaust fan 52. If any one of the connection part between each supply perforated pipe 71 and the supply duct 11 and the connection parts between each exhaust perforated pipe 72 and the exhaust duct 12 is sealed, air circulation between the inner space and the outer space of the object 100 cannot be performed, and thus, if it is determined that at least one of the connection parts between each supply perforated pipe 71 and the supply duct 11 and the connection parts between each exhaust perforated pipe 72 and the exhaust duct 12 is sealed, the control unit stops the drives of the supply fan 51 and the exhaust fan 52 so as to prevent each of the fans 51 and 52 from overheating and to prevent unnecessary power consumption.

In addition, control unit stops the supply fan 51 and the exhaust fan 52, if the measurement result indicates that the connection parts between each supply perforated pipe 71 and the supply duct 11 and the connection parts between each exhaust perforated pipe 72 and the exhaust duct 12 are all sealed and temperature of the inner space of the object is lower than or equal to a critical temperature, and drives the supply fan 51 and the exhaust fan 52, if the measurement result indicates that the connection parts between each supply perforated pipe 71 and the supply duct 11 and the connection parts between each exhaust perforated pipe 72 and the exhaust duct 12 are all opened and the temperature of the inner space of the object is higher than the critical temperature. Here, the critical temperature means a minimum temperature at which an apparatus installed in the inner space of the object 100 can be degraded.

As such, according to the present embodiment, in order to prevent an apparatus installed in the inner space of the object 100 from degrading, breaking down, or the like due to overheat and to minimize power consumption according to the drives of each of the fans 51 and 52, the supply fan 51 and the exhaust fan 52 are driven only if the connection parts between each supply perforated pipe 71 and the supply duct 11 and the connection parts between each exhaust perforated pipe 72 and the exhaust duct 12 are all opened and the temperature of the inner space of the object is higher than the critical temperature. That is, in the present embodiment, only if the temperature of the inner space of the duct the duct 10 is higher than the critical temperature, forcible air circulation between the inner space and the outer space of the object 100 is performed, and thereby, the apparatus installed in the inner space of the object 100 can be cooled rapidly. If the temperature of the inner space of the object 100 is lower than or equal to the critical temperature, the apparatus installed in the inner space of the object 100 can be cooled by natural convection between the inner space and the outer space of the object 100 which is generated according to the opened connection parts between each supply perforated pipe 71 and the supply duct 11 and the opened connection parts between each exhaust perforated pipe 72 and the exhaust duct 12. As such, in the present embodiment, if an apparatus in the inner space of the object 100 is overheated, the apparatus can be rapidly cooled, and power consumption according to the drives of each of the fans 51 and 52 can be minimized by making the best use of cooling which is performed by the natural convection.

The preferred embodiments according to the present invention are described so far. Those skilled in the art to which the present invention belongs can understand that the present invention can be realized by modified forms in a range without departing from the essential characteristics of the present invention. Thus, the disclosed embodiments have to be considered in a descriptive sense rather than a restrictive sense. The scope of the present invention is represented in the scope of claims rather than the aforementioned description, and all differences in the same scope as that should be construed as being included in the present invention.

1. An air conditioning device comprising:
at least one ventilation pipe whose lower end is coupled to a peripheral surface of at least one vent of an object at the outside of the object so as to communicate with an inner space of the object;
at least one perforated pipe which is installed to be erected on a flat outer surface of the object in parallel with the each ventilation pipe;
a duct which is connected between upper ends of the each ventilation pipe and an upper end of the at least one perforated pipe such that the each ventilation pipe and the at least one perforated pipe communicate with each other; and
at least one floating body which is positioned in each inner space of the at least one perforated pipe, and vertically moves in the inner spaces of the each perforated pipe according to the amount of water flowing in through holes of the each perforated pipe,
wherein connection parts between the each perforated pipe and the duct are opened or sealed by means of vertical movements of the each floating body such that the inner space of the object is ventilated with outside air through the ventilation pipe or the inner space of the object is closed.

2. The air conditioning device according to claim 1,
wherein the each floating body is lighter than buoyance of water and is a circular ball at one side of which a protruding rod is formed, and
wherein the air conditioning device further includes a guide member which is installed on the upper end sides of the each perforated pipe and guides vertical movements of the each floating body by including paths in which the protruding rods of the each floating body are inserted to slidably move while air passes through the paths.

3. The air conditioning device according to claim 2, further comprising:
a sealing packing of a circular shape whose upper surface is coupled to a lower surface of the guide member in a sealed state and in which a circular opening is formed in a center thereof,
wherein, if water flows into holes of the each perforated pipe and the each perforated pipe is immersed in water at a height above a critical water level, circular outer surfaces of the each floating body press peripheries of holes of the each sealing packing and thereby connection parts between the each perforated pipe and the duct are sealed.

4. The air conditioning device according to claim 3, wherein the each perforated pipe has a larger diameter than a maximum diameter which can be immersed in water flowing into the holes of the each perforated pipe at a maximum flow speed.

5. The air conditioning device according to claim 1,
wherein the at least one perforated pipe is a plurality of perforated pipes which are installed to be erected on a flat outer surface of the object in parallel with the ventilation pipe, and
wherein the duct is connected between upper ends of the each ventilation pipe and upper ends of the plurality of perforated pipes such that the each ventilation pipe and the plurality of perforated pipes communicate with each other.

6. The air conditioning device according to claim 1,
wherein the at least one ventilation pipe includes a supply pipe whose lower end is coupled to a periphery of a supply hole of the object in a sealed state and which communicates with an inner space of the object, and an exhaust pipe which is coupled to a periphery of an exhaust hole of the object in a sealed state and communicates with the inner space of the object,
wherein the at least one perforated pipe includes at least one supply perforated pipe which is installed to be erected on the flat outer surface of the object in parallel with the supply pipe, and at least one exhaust perforated pipe which is installed to be erected on the flat outer surface of the object in parallel with the exhaust pipe, and
wherein the duct includes a supply duct which is connected between an upper end of the supply pipe and an upper end of the at least one supply perforated pipe such that the supply pipe and the at least one supply perforated pipe communicate with each other, and an exhaust duct which is connected between an upper end of the exhaust pipe and an upper end of the at least one exhaust perforated pipe such that the exhaust pipe and the at least one exhaust perforated pipe communicate with each other.

7. The air conditioning device according to claim 6, further comprising:
a fan which is coupled to a periphery surface of the supply hole of the object in an inside of the object so as to absorb air from the outside of the object, which is coupled to a periphery surface of the exhaust hole of the object in an inside of the object so as to exhaust air to the outside of the object through the exhaust pipe, and which forcibly circulates the air that is absorbed through the supply pipe in the inner space of the object to exhaust the air through the exhaust pipe.

8. The air conditioning device according to claim 7,
wherein the fan includes:
a supply fan which is coupled to the peripheral surface of the supply hole of the object in a sealed state or non-sealed state and absorbs air from the outside of the object through the supply pipe; and
an exhaust fan which is coupled to the peripheral surface of the exhaust hole of the object in a non-sealed state and exhausts air to the outside of the object through the exhaust pipe, and
wherein a gap which enables wind power smaller than buoyance of a floating body occurring due to water that is flowed in through the holes of the each exhaust perforated pipe to act on a floating body that is positioned in an inner space of the each exhaust perforated pipe is formed between the exhaust fan and the peripheral surface of the exhaust hole of the object.

9. The air conditioning device according to claim 7, further comprising:
a control unit which measures at least one of positions of each floating body in the inner spaces of the each supply perforated pipe and positions of each floating body in the inner spaces of the each exhaust perforated pipes, and controls drive of the fan depending on whether or not the measurement result indicates at least one sealing of connection parts between the each supply perforated pipe and the supply duct and connection parts between the each exhaust perforated pipe and the exhaust duct.

10. The air conditioning device according to claim 9,
wherein the fan includes:
a supply fan which is coupled to the peripheral surface of the supply hole of the object and absorbs air from the outside of the object through the supply pipe; and
an exhaust fan which is coupled to the peripheral surface of the exhaust hole of the object and exhausts air to the outside of the object through the exhaust pipe, and
wherein the control unit stops drives of the supply fan and the exhaust fan if the measurement result indicates at least one sealing of the connection parts between the each supply perforated pipe and the supply duct and the connection parts between the each exhaust perforated pipe and the exhaust duct, stops the drives of the supply fan and the exhaust fan if the measurement result indicates opening of all of the connection parts between the each supply perforated pipe and the supply duct and connection parts between the each exhaust perforated pipe and the exhaust duct and temperature of the inner space of the object is lower than or equal to a critical temperature, and drives the supply fan and the exhaust fan if the measurement result indicates opening of all of the connection parts between the each supply perforated pipe and the supply duct and connection parts between the each exhaust perforated pipe and the exhaust duct and the temperature of the inner space of the object is higher than the critical temperature.

11. The air conditioning device according to claim 9, further comprising:
a proximity sensor which is installed on at least one of upper end sides of the each supply perforated pipe and upper end sides of the each exhaust perforated pipe, detects degrees of proximity of each floating body vertically moving in inner spaces of the each supply perforated pipe, and detects degrees of proximity of each floating body vertically moving in inner spaces of the each exhaust perforated pipe,
wherein the control unit measures positions of each floating body in inner spaces of the each supply perforated pipe from the degrees of proximity of each floating body vertically moving in the inner spaces of the each supply perforated pipe, and measures positions of each floating body in inner spaces of the each exhaust perforated pipe from the degrees of proximity of each floating body vertically moving in the inner spaces of the each exhaust perforated pipe.
